(19) United States
(12) Patent Application Publication
(10) Pub. No.: US 2012/0082746 A1
(43) Pub. Date: Apr. 5, 2012

(54) MOLD HAVING SLIDE

(75) Inventors: JIAN-MING LI, Tu Cheng (TW); Xiao-ping Wu, Tu Cheng (TW); Shih-hsiung Ho, Tu Cheng (TW)

(73) Assignee: Cheng Uei Precision Industry Co., LTD., Tu Cheng City (TW)

(21) Appl. No.: 12/895,351

(22) Filed: Sep. 30, 2010

(51) Int. Cl. B28B 1/093

(52) U.S. Cl. 425/411

(57) ABSTRACT

A mold having slide is disclosed, including an upper mold plate, a lower mold plate mating with the upper mold plate, a slanted guide post, a slide, and a locating mechanism. The slanted guide post is mounted on the upper mold plate. The slide and the locating mechanism are both mounted on the lower mold plate. The locating mechanism has a locating stop. The locating stop is fixed to the lower mold plate. The locating stop has a pull rod movably mounted thereto with one end of the pull rod fixed to the slide. A compression spring is located between an opposite end of the pull rod and the locating stop. The mold can effectively prevent the slide from undesired move-back and thus being incorrectly positioned so as to eliminate the potential risk of damage of the mold by the slanted guide post.

### BACKGROUND OF THE INVENTION

1. Field of the Invention

The present invention generally relates to a mold, and in particular to a mold having a slide.

2. The Related Arts

Reference is now made to FIG. 3 of the attached drawings, which shows a conventional mold 100′. The mold 100′ comprises an upper mold plate 10′, a lower mold plate 20′, a slide 30′ which is slidably mounted on the lower mold plate 20′, a slanted guide post 40′, and a locating pin 50′. The slide 30′ forms a guide groove (not labeled) vertically extending through the slide 30′. The slanted guide post 40′ is fixed on the upper mold plate 10′ and has a lower end movably received through the guide groove of the slide 30′. The lower mold plate 20′ is provided with a locating hole 201′. The locating pin 50′ is received in the locating hole 201′ and has one end protruding beyond an upper surface of the lower mold plate 20′. When the mode 100′ is being opened, the slanted guide post 40′ causes the slide 30′ to slide outward, and the portion of the locating pin 50′ protruding beyond the upper surface of the lower mold plate 20′ limits the sliding motion of the slide 30′ and thus set a stop location for the slide.

However, in the mold 100′, since the end of the slide 30′ must mount across the upper end of the locating pin 50′, and this imposes a limitation to the size of the portion of the locating pin 50′ that protrudes beyond the upper surface of the lower mold plate 20′. As a consequence, when the mode is opened after a product is formed, the slide 30′ may easily slide over the locating pin 50′, leading to undesired separation of the slide 30′ from the mold 100′. This may cause damage to the mold 100′ when the mold is closed again.

### SUMMARY OF THE INVENTION

An objective of the present invention is to overcome the problem discussed above by providing a mold having slide that is capable of reliably locating the slide.

To achieve the above objective, the present invention provides a mold having slide, which comprises an upper mold plate, a lower mold plate mating with the upper mold plate, a slanted guide post, a slide, and a locating mechanism. The slanted guide post is mounted to the upper mold plate. The slide is slidably mounted on the lower mold plate. The locating mechanism is mounted on the lower mold plate and comprises a locating stop. The locating stop is fixed to the lower mold plate and comprises a pull rod. One end of the pull rod is fixed to the slide, and a compression spring is located between an opposite end of the pull rod and the locating stop.

As described above, the mold according to the present invention can effectively prevent the slide from undesired move-back and thus being incorrectly positioned to thereby eliminate the potential risk of damage of the mold by the slanted guide post.

### BRIEF DESCRIPTION OF THE DRAWINGS

The present invention will be apparent to those skilled in the art by reading the following description of a preferred embodiment of the present invention, with reference to the attached drawings, in which:

FIG. 1 is a cross-sectional view showing a mold having slide according to the present invention in a mold-closed condition;

FIG. 2 is a cross-sectional view showing mold having slide of FIG. 1 in a mold-open condition; and

FIG. 3 is a cross-sectional view of a conventional mold.

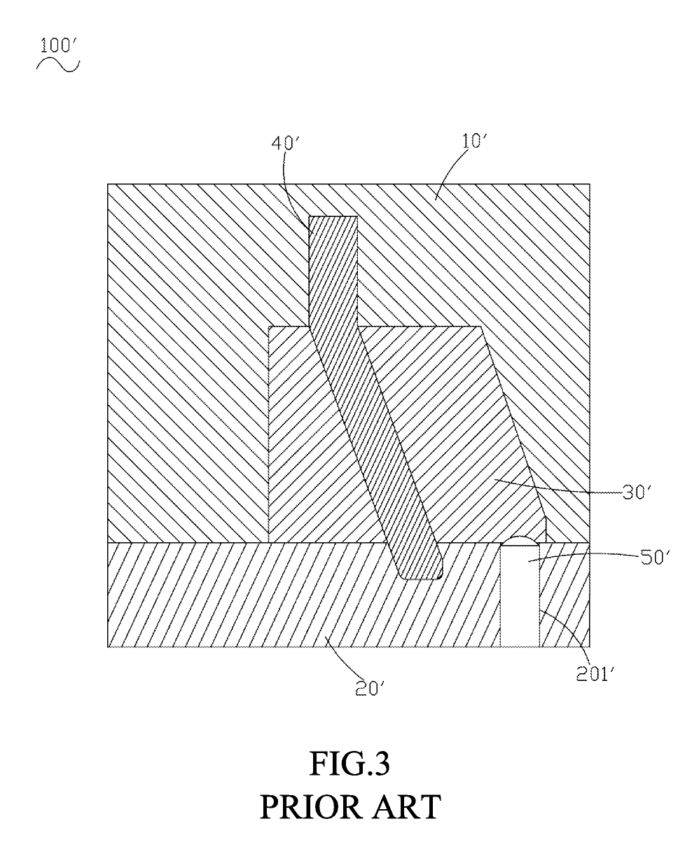

### DETAILED DESCRIPTION OF THE PREFERRED EMBODIMENT

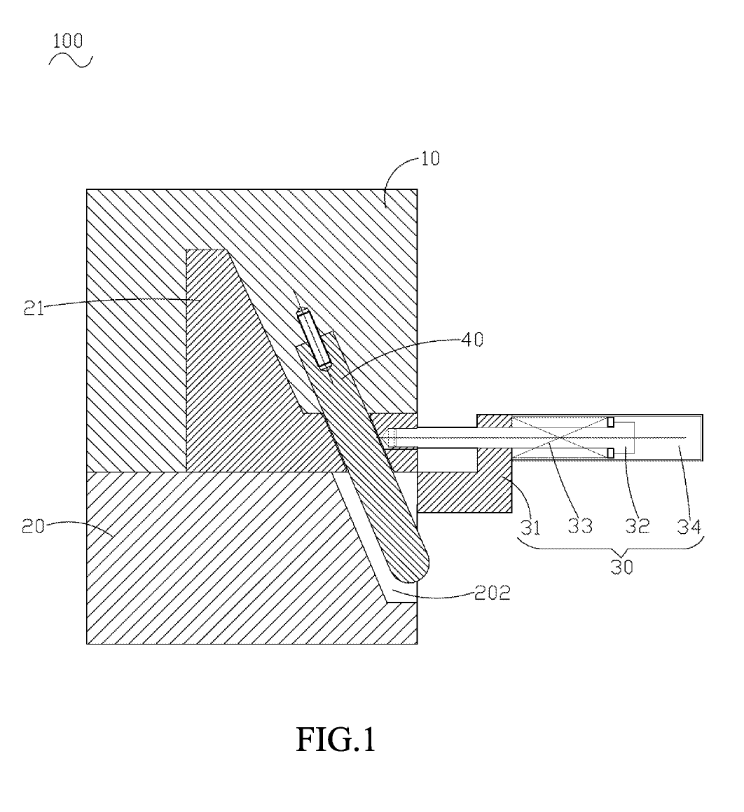

With reference to the drawings and in particular to FIG. 1, the present invention provides a mold having slide, generally designated at 100. The mold 100 comprises an upper mold plate 10, a lower mold plate 20, a locating mechanism 30, and a slanted guide post 40.

The lower mold plate 20 is mating with the upper mold plate 10 and comprises a slide 21. An upper surface of the lower mold plate 20 forms a slide channel (not shown). One side of the slide channel is provided with two glide groove 202 slantwise and downward. The slide 21 is movably received in the slide channel. An upper surface of the slide 21 forms two glide holes 211, and a lateral side of the slide 21 forms a locating blind hole (not labeled).

The locating mechanism 30 comprises a locating stop 31, a pull pod 32, a compression spring 33, and a compression spring protecting cover 34. The locating stop 31 is fixed on the lower mold plate 20. The locating stop 31 is a plate showing an “L” shape. A travel distance is present between the locating stop 31 and the slide 21 when mold is closed. One end of the pull pod 32 is fit to the locating blind hole of the slide 21. The compression spring 33 is located between one side of the locating stop 31 and an opposite end of the pull pod 32. The compression spring protecting cover 34 is fixed on the locating stop 31 and encloses the compression spring 33.

The slanted guide post 40 extends through the glide hole 211 and is fit into the glide groove 202 of the lower mold plate 20.

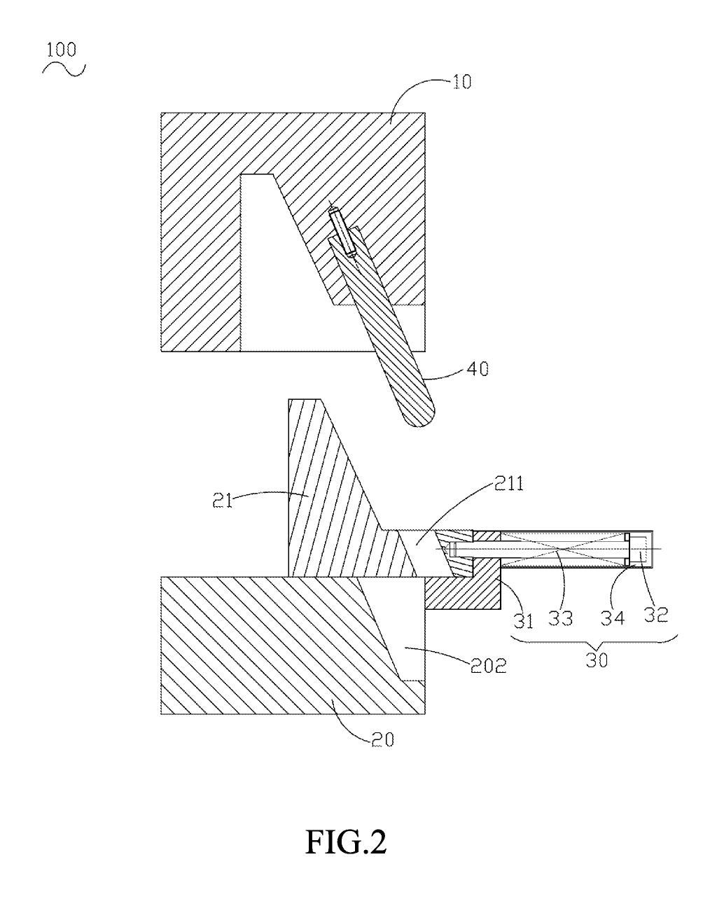

Referring to FIG. 2, when the mold 100 according to the present invention is being opened, the slanted guide post 40 is moving upward and drives the slide 21 to move outward. At the same time, the pull pod 32 also moves outward to free the compression spring 33 for expansion. Then, once one side of the slide 21 is brought into engagement with an opposing side of the locating stop 31, the slide 21 is securely held in position by the spring force of the compression spring 33 due to the free expansion of the spring 33. This helps preventing the slide 21 from undesirably moving backward, leading to damage of the mold caused by the slanted guide post 40 at the time when the mold 100 is being closed. In addition, this also helps effectively preventing the potential risk that the compression spring 33 springs off when the pull pod 32 gets loosened because the compression spring protecting cover 34 is provided to enclose the compression spring 33. When the mold 100 is closed, the slide 21 moves away from the locating stop 31 to a designated location and the compression spring 33 is compressed by the pull rod 32 and returns to the original condition before the mold is opened, whereby subsequent operation can be carried out after the mode 100 is completely closed.

As described above, the mold 100 according to the present invention can effectively prevent the slide 21 from undesired move-back and thus incorrect positioning at the time when the mold 100 is being opened with the arrangement of the locating mechanism 30, so that the potential risk that the mold is damaged by the slanted guide post 40 is eliminated.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A mold, comprising:
an upper mold plate;
at least one slanted guide post, which is mounted on the upper mold plate;
a lower mold plate, which is mating with the upper mold plate;
at least one slide, which is movably mounted on the lower mold plate; and
a locating mechanism, which is mounted on the lower mold plate and comprises a locating stop, which is fixed on the lower mold plate and comprises a pull pod movably mounted thereto, the pull pod having an end fixed to the slide and an opposite end supporting a compression spring with respect to the locating stop.

2. The mold as claimed in claim 1, wherein the locating mechanism comprises a compression spring protecting cover which is fixed on the locating stop and encloses the compression spring.
